(19) United States
(12) Patent Application Publication
(10) Pub. No.: US 2022/0103051 A1
(43) Pub. Date: Mar. 31, 2022

(54) VIBRATION GENERATOR

(71) Applicant: Faurecia Clarion Electronics Co., Ltd., Saitama-shi (JP)

(72) Inventor: Kenji KONO, Saitama-shi (JP)

(73) Assignee: Faurecia Clarion Electronics Co., Ltd., Saitama-shi (JP)

(21) Appl. No.: 17/298,022

(22) PCT Filed: Dec. 6, 2019
(86) PCT No.: PCT/JP2019/047856

§ 371 Date: May 28, 2021

(30) Foreign Application Priority Data
Dec. 7, 2018 (JP) 2018-229842

(51) Int. Cl. H02K 33/16; B06B 1/04; H02K 5/18

(52) U.S. Cl. CPC H02K 33/16; H02K 41/0356; H02K 5/18; B06B 1/045

(57) ABSTRACT

A vibration generator that allows the user to feel sufficient vibration and that has excellent heat-releasing performance is provided. A vibration generator (100a) has a case (110), a shaft member (130) provided inside the case (110), a moving part (140) configured to move back and forth inside the case (110) along the shaft member (130), and a vibration transmission member (150) configured to have one end fixed to the case (110). The vibration transmission member (150) has an inner space S1 formed inside and an opening part (151) to connect between the inner space (S1) and the outside. An end part (133) of the shaft member (130) penetrates out from the inside of the case (110) and extends to the inner space (S1) of the vibration transmission member (150).

### TECHNICAL FIELD

The present invention relates to a vibration generator. More particularly, the present invention relates to a vibration generator that generates vibration by allowing a moving part to move back and forth inside a case.

### BACKGROUND ART

Conventionally, a vibration generator has been proposed, in which vibration is generated by a vibration unit installed in a seat or the like, to give notice to the seated person (see, for example, patent literature 1 (pages 5 to 7 (in particular, paragraph [0038], etc.), FIG. 2 and FIG. 3)). The vibration unit has a pair of vibrators that generate vibrations, a plate-like member that is fixed to each vibrator, and an enclosing member that covers the vibrators and the plate-like member. The vibration unit is installed in a concave part of a buffer member provided in the seating portion of the seat. The enclosing member is filled to surround the vibrators tightly and arranged between the vibrating planes of the vibrators and the buffer member of the seating portion tightly.

In this way, in a state in which the vibration unit is arranged in the seating portion of the seat, vibration is generated with the vibrators so as to allow the seated person to feel the vibration.

### CITATION LIST

### Patent Literature

PTL 1: Japanese Unexamined Patent Application Publication No. 2018-144454

### SUMMARY OF INVENTION

### Technical Problem

However, since the above-described vibration generator is installed in the buffer member (in the concave part) of the seat in a state in which the enclosing member is filled to surround the vibrators tightly and arranged between the vibrating planes of the vibrators and the buffer member of the seating portion tightly, it is not easy to ensure sufficient heat-releasing performance.

In particular, to allow the seated person to feel greater vibration, it is necessary to increase the magnitude of input signals to input in the vibrators, the amount of current, and so forth. When the magnitude of input signals and the amount of current increase, the amount of heat generated by the vibrators increases, making it even more difficult to ensure sufficient heat-releasing performance.

For example, there is a problem that, even when heat is generated in the magnetic circuit of the vibration unit when the vibrators vibrate, since the enclosing member covers and surrounds the vibrators tightly, it is difficult to smoothly discharge the heat generated in the vibration unit, to the outside of the seating portion.

Meanwhile, although removing the enclosing member might make it easier to release heat, it is still difficult to make the seated person feel vibration with sufficient strength because a gap is formed between the vibrating planes of the vibrators and the buffer member of the seating portion.

The present invention has been made in view of the foregoing, and it is therefore an object of the present invention to provide a vibration generator that allows the user to feel sufficient vibration, and that has excellent heat-releasing performance.

### Solution to Problem

A vibration generator according to one aspect of the present invention includes a case, a shaft member provided inside the case, a moving part configured to move back and forth inside the case along the shaft member, and a vibration transmission member configured to have one end fixed to the case. The vibration transmission member includes an inner space formed therein and an opening part to connect between the inner space and outside. An end part of the shaft member penetrates out from the inside of the case, and extends to the inner space of the vibration transmission member.

With the vibration generator of the above aspect, the moving part moves back and forth along the shaft member. Consequently, heat can be generated between the moving part and the shaft member due to the back-and-forth movement of the moving part. With the vibration generator of the above aspect of the present invention, an end part of the shaft member provided inside the case penetrates out of the case and extends to the inner space of the vibration transmission member. Consequently, the heat generated between the moving part and the shaft member can be transmitted to the inner space of the vibration transmission member through the shaft member. The inner space of the vibration transmission member is connected to the outside through an opening part of the vibration transmission member. Therefore, the heat transmitted to the inner space allows to be discharged to the outside through the opening part, so that it is possible to improve the heat-releasing performance of the vibration generator.

The vibration generated by the back-and-forth movement of the moving part is amplified by the action and reaction of the case and others in response to the back-and-forth movement of the moving part, and transmitted to the case and others. With the vibration generator of the above aspect of the present invention, the vibration transmission member is configured to have one end fixed to the case, so that the vibration transmitted to the case can be transmitted far through the vibration transmission member, and, furthermore, the attenuation of vibration in the course of transmission can be reduced. Consequently, it allows the user to feel vibration with sufficient strength in a wider range.

With the vibration generator of the above aspect, the case may include a communicating hole to connect between the inner space of the vibration transmission member and the inside of the case.

With the vibration generator of the above aspect, the moving part moves back and forth inside the case, so that the temperature inside the case may increase following the back-and-forth movement. With the vibration generator of the above aspect of the present invention, a communicating hole is formed to connect between the inner space of the vibration transmission member and the inside of the case, so that, even if the temperature inside the case increases following the back-and-forth movement of the moving part, it is still possible to discharge the heat inside the case to the inner space of the vibration transmission member through the communicating hole. The inner space is connected to the outside through the opening part of the vibration transmission member. Consequently, it is possible to discharge the heat discharged into the inner space to the outside of the vibration transmission member, through the opening part, so that it is possible to improve the heat-releasing performance of the vibration generator.

With the vibration generator of the above aspect, the vibration transmission member may be provided at one end of the case on a side corresponding to a direction in which the moving part moves forward, and may also be provided, separately, at the other end of the case on a side corresponding to a direction in which the moving part moves backward. The communicating hole may be formed at the one end of the case on the side corresponding to the direction in which the moving part moves forward, and may also be formed, separately, at the other end of the case on the side corresponding to the direction in which the moving part moves backward.

With the vibration generator of the above aspect of the present invention, a communicating hole is formed both at one end of the case on the side corresponding to the direction in which the moving part moves forward and at the other end of the case on the side corresponding to the direction in which the moving part moves backward. Consequently, when the moving part moves forward, the air (hot air) inside the case is discharged to the outside of the case (into the inner space of the vibration transmission member) from the communicating hole formed at the one end of the case on the forward-direction side, and, furthermore, air (air with relatively low temperature) outside the case (the inner space of the vibration transmission member) is guided into the case from the communicating hole formed at the other end of the case on the backward-direction side. On the other hand, when the moving part moves backward, the air (hot air) inside the case is discharged from the communicating hole formed at the other end of the case on the backward-direction side, to the outside of the case (into the inner space of the vibration transmission member), and, furthermore, air (air with relatively low temperature) outside the case (the inner space of the vibration transmission member) is guided into the case through the communicating hole formed at the one end of the case on the forward-direction side.

In this way, with the vibration generator according to the above aspect of the present invention, the air (hot air) inside the case is discharged to the outside of the case through one communicating hole, following the back-and-forth movement of the moving part, and, furthermore, air (air with relatively low temperature) from outside is guided into the case through the other communicating hole, so that it is possible to replace the air inside the case quickly. Thus, it is possible to circulate the air inside the case actively, following the back-and-forth movement of the moving part, and to improve the heat-releasing performance of the vibration generator.

With the vibration generator of the above aspect, the shaft member may include a hollow space connecting between the inner space of the vibration transmission member and the inside of the case.

With the vibration generator of the above aspect, the moving part moves back and forth inside the case, so that the temperature inside the case can be increased by following the back-and-forth movement. With the vibration generator of the above aspect of the present invention, the shaft member has a hollow space formed to connect between the inner space of the vibration transmission member and the inside of the case, so that, even if the temperature inside the case increases following the back-and-forth movement, it is still possible to discharge the air (hot air) inside the case to the inner space of the vibration transmission member, through the hollow space. Since the inner space is connected to the outside through the opening part of the vibration transmission member, it is possible to discharge the air (hot air) discharged into the inner space to the outside of the vibration transmission member through the opening part, and it is possible to improve the heat-releasing performance of the vibration generator.

With the vibration generator of the above aspect, the vibration transmission member may be provided at the one end of the case on the side corresponding to the direction in which the moving part moves forward, and may also be provided, separately, at the other end of the case on the side corresponding to the direction in which the moving part moves backward. The shaft member may include a hollow space connecting between the inner space of the vibration transmission member provided at the one end of the case, and the inside of the case, and a hollow space connecting between the inner space of the vibration transmission member provided at the other end of the case, and the inside of the case.

With the vibration generator of the above aspect of the present invention, the shaft member has a hollow space formed to connect between the inner space of the vibration transmission member provided at one end of the case on the side corresponding to the direction in which the moving part moves forward, and the inside of the case, and a hollow space formed to connect between the inner space of the vibration transmission member provided separately at the other end of the case on the side corresponding to the direction in which the moving part moves backward, and the inside of the case. Consequently, when the moving part moves forward, the air (hot air) inside the case travels through the hollow space in the shaft member and is discharged into the inner space of the vibration transmission member provided at one end of the case (outside the case), and, furthermore, the air (air with relatively low temperature) in the inner space of the vibration transmission member provided separately at the other end of the case (outside the case) travels through the hollow space in the shaft member and is guided into the case. On the other hand, when the moving part moves backward, the air (hot air) inside the case travels through the hollow space in the shaft member and is discharged into the inner space of the vibration transmission member provided at the other end of the case (outside the case), and, furthermore, the air (air with relatively low temperature) in the inner space of the vibration transmission member provided separately at the one end of the case (outside the case) travels through the hollow space in the shaft member and is guided into the case.

In this way, with the vibration generator of the above aspect of the present invention, the air (hot air) inside the case is discharged to the outside through the hollow space in the shaft member, following the back-and-forth movement of the moving part, and air (air with relatively low temperature) from outside is guided into the case through the hollow space in the shaft member, so that it is possible to replace the air inside the case quickly. Therefore, the air inside the case can be actively circulated following the back-and-forth movement of the moving part, so that it is possible to improve the heat-releasing performance of the vibration generator.

Note that, as long as space to connect between the inner space of the vibration transmission member on the side corresponding to the direction in which the moving part moves forward, and the inside of the case, and space to connect between the inner space of the vibration transmission member on the side corresponding to the backward direction, and the inside of the case, are provided, the hollow spaces to be formed in the shaft member may be separate spaces or one space. Whether these hollow spaces are separate spaces or one space, the air inside the case can be actively circulated following the back-and-forth movement of the moving part, so that it is possible to improve the heat-releasing performance of the vibration generator.

### Advantageous Effects of Invention

With the vibration generator according to one embodiment of the present invention, an end part of the shaft member provided inside the case penetrates out of the case and extends to the inner space of the vibration transmission member. Consequently, heat generated between the moving part and the shaft member can be transmitted to the inner space of the vibration transmission member through the shaft member. The inner space is connected to the outside through an opening part of the vibration transmission member. Therefore, the heat transmitted to the inner space can be discharged to the outside through the opening part, so that it is possible to improve the heat-releasing performance of the vibration generator.

In addition, the vibration generated by the back-and-forth movement of the moving part is amplified by the action and reaction of the case and others in response to the back-and-forth movement of the moving part, and transmitted to the case and others. With the vibration generator according to one embodiment of the present invention, the vibration transmission member is configured to have one end fixed to the case, so that the vibration transmitted to the case can be transmitted far through the vibration transmission member, and, furthermore, the attenuation of vibration in the course of transmission can be reduced. Consequently, it allows the user to feel vibration with sufficient strength in a wider range.

### BRIEF DESCRIPTION OF DRAWINGS

FIG. 1 is a cross-sectional side view showing a schematic configuration of a seat with a vibration generator according to a first embodiment;

FIG. 2 is a cross-sectional side view showing the vibration generator shown in FIG. 1;

FIG. 3 is a cross-sectional side view showing a schematic configuration of a seat with a vibration generator according to a second embodiment;

FIG. 4 is a cross-sectional side view showing the vibration generator shown in FIG. 3;

FIG. 5 is a cross-sectional side view showing a vibration generator according to a third embodiment;

FIG. 6 is a cross-sectional side view showing a modification of the vibration generator according to the third embodiment;

FIG. 7 is a cross-sectional side view showing a vibration generator according to a fourth embodiment; and

FIG. 8 is a cross-sectional side view showing a modification of the vibration generator according to the fourth embodiment.

### DESCRIPTION OF EMBODIMENTS

Now, examples of vibration generators according to embodiments of the present invention will be described below in detail with reference to the accompanying drawings.

### First Embodiment

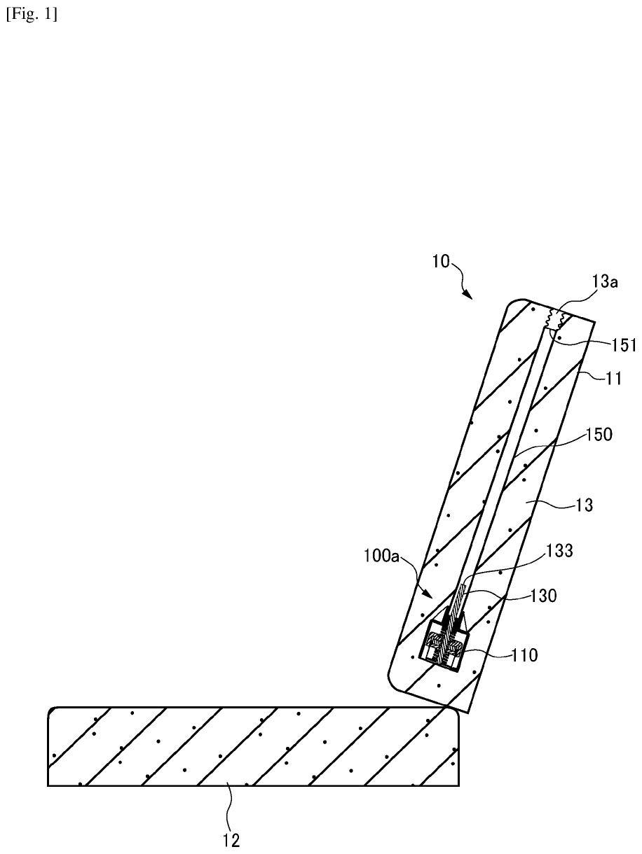

FIG. 1 is a cross-sectional side view showing a schematic configuration of a seat with a vibration generator according to a first embodiment. A seat 10 includes a backrest 11 and a seating portion 12. The backrest 11 has a frame (not shown) and a cushion member (elastic member) 13 provided to cover the outside of the frame. A vibration generator 100a is provided inside the cushion member 13 so that the longitudinal direction of the vibration generator 100a runs along the vertical direction (longitudinal direction) of the backrest 11.

With the seat 10 shown in FIG. 1, a configuration in which the vibration generator 100a is provided in the backrest 11 is shown, but the location to install the vibration generator 100a is not limited to the backrest 11. It is also possible to provide the vibration generator 100a in the seating portion 12, the headrest of the seat 10 (not shown), the elbow rest part (not shown), and so forth.

In an upper part of the cushion member 13, in the direction in which the upper end of the vibration generator 100a extends, a space 13a that communicates with the outside of the seat 10 from the end of the vibration generator 100a (an opening part 151 of a vibration transmission member 150 to be described later) is formed. This space 13a serves as a passage for discharging the heat generated from the vibration generator 100a to the outside of the seat 10.

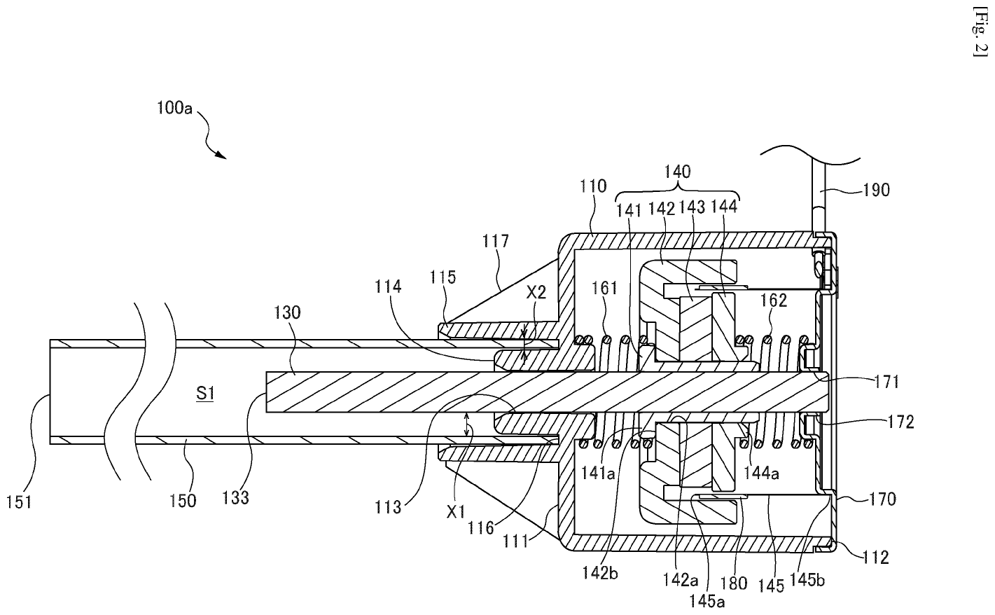

FIG. 2 is a cross-sectional side view showing a schematic configuration of the vibration generator 100a. As mentioned above, the vibration generator 100a is provided inside the cushion member 13 so that the longitudinal direction of the vibration generator 100a runs along the vertical direction (longitudinal direction) of the backrest 11. For the convenience of description, FIG. 2 is shown so that the longitudinal direction of the vibration generator 100a is the left-right direction on the drawing sheet.

The vibration generator 100a roughly includes a case 110, a shaft member 130, a movable part (moving part) 140, a vibration transmission member 150, a pair of springs 161 and 162, and a voice coil bobbin 145, as shown in FIG. 2. The case 110 assumes a cylindrical shape with a bottom (columnar outer shape). In FIG. 2, the bottom portion 111 is shown to be turned to the left side on the drawing sheet, and the opening portion 112 is shown to be turned to the right side on the drawing sheet.

A shaft member 130 is installed in the center of the case 110, in the direction in which the central axis of the case 110 extends. More particularly, a throughhole 113 for penetrating with the shaft member 130 is formed in the center of the bottom portion 111 of the case 110, and, in addition, a first edge part 114 that abuts on the outer periphery of the shaft member 130 is formed at the edge portion of the throughhole 113. The shaft member 130 arranged in and penetrating the throughhole 113 is fixed to the first edge part 114, so that the main body on one end side of the shaft member 130 is located inside the case 110, and the end part 133 on the other end side (at least the end plane of the end part 133) thereof is exposed to the outside of the case 110.

The movable part 140 is configured to move back and forth along the shaft member 130, as described later. It then follows that the shaft member 130 has a function for defining the direction in which the movable part 140 can move. In addition, the shaft member 130 is configured to transmit (discharging) the heat generated by the back-and-forth movement of the movable part 140 from the inside to the outside of the case 110. In order to allow the heat to transmit from the inside to the outside of the case 110, the shaft member 130 is made of, for example, a rod-like member of a metal having high thermal conductivity or the like. A rod-like body having a round cross section is used for the shaft member 130 according to the first embodiment.

The first edge part 114 formed in the bottom portion 111 of the case 110 is formed in a shape (for example, boss or the like) that protrudes to the outside and the inside of the case 110, and the portion that protrudes into the case 110 assumes a cylindrical shape having a diameter to match the inner diameter of the spring 161. In addition, the portion of the first edge part 114 protruding out of the case 110 assumes a cylindrical shape that covers the outer periphery of the shaft member 130 with a fixed thickness X1. In addition, in the bottom portion 111 of the case 110, an annular second edge part 115, which faces the outer peripheral plane of the first edge part 114 outside the case 110 at a fixed distance X2, is formed. The fixed distance X2 is provided between the first edge part 114 and the second edge part 115, so it follows that the outer peripheral plane of the first edge part 114, the inner peripheral plane of the second edge part 115 and the outer wall of the bottom portion 111 of the case 110 form an annular groove 116. Also, multiple ribs 117 are provided between the outer peripheral plane of the second edge part 115 and the outer plane of the bottom portion 111 of the case 110.

A lid member 170 is attached to the opening portion 112 of the case 110. An opening part 171 for fixing the shaft member 130 is also formed in the center of the lid member 170, and a third edge part 172 is formed in a peripheral edge of the opening part 171. It then follows that, when the shaft member 130 is fixed to the case 110, a portion of the shaft member 130 is fixed by the first edge part 114, and the end part of the shaft member 130 is fixed by the third edge part 172. A portion of the third edge part 172 on the inner side of the case 110 is formed so as to protrude into the case 110. The portion protruding into the case 110 assumes a cylindrical shape having a diameter width to match the inner diameter of the spring 162.

The movable part 140 includes a bearing part 141, a yoke 142, a magnet 143, and a pole 144. The bearing part 141 assumes a cylindrical shape, and is attached so that it can move back and forth along the shaft member 130, in a state in which the shaft member 130 penetrates inside the cylinder. The bearing part 141 is a member for assisting the movable part 140 to move smoothly along the axial direction of the shaft member 130. Consequently, the bearing part 141 serves as a sliding member. A locking part 141a that locks with an end plane of the yoke 142 is provided at one end part of the bearing part 141. The dimension of the locking part 141a in the radial direction matches the inner diameter of the spring 161.

The yoke 142, the magnet 143, and the pole 144 are fixed to the bearing part 141. The pole 144 is an iron member having high magnetic permeability, and the yoke 142 is a member that efficiently transmits the magnetic force of the magnet 143 to the pole 144 to produce a magnetic flux (a magnetic field).

The yoke 142 assumes a cylindrical shape with a bottom, and a throughhole 142a to insert and fix the bearing part 141 is formed in the center of the bottom portion (i.e., the left portion of FIG. 2). A locking groove 142b to lock with the locking part 141a of the bearing part 141 is formed at the edge portion of the throughhole 142a. The outer diameter of the yoke 142 is smaller than the inner diameter of the case 110, and a gap is provided between the inner peripheral plane of the case 110 and the outer peripheral plane of the yoke 142. This gap prevents the outer peripheral plane of the yoke 142 from contacting the inner peripheral plane of the case 110, even when the movable part 140 moves back and forth along the axial direction of the shaft member 130 (moves to the left and right in the sheet of FIG. 2).

The magnet 143 and the pole 144 assume ring shapes, where each ring hole has the bearing part 141 inserted therein. The outer diameters of the ring shapes of the magnet 143 and the pole 144 are smaller than the inner diameter of the yoke 142. The magnet 143 is housed inside the yoke 142 from the end part on the open side of the yoke 142 (right-side end part in FIG. 2), and, furthermore, the pole 144 is housed. In this way, the yoke 142, the magnet 143 and the pole 144 are connected in a state in which the magnet 143 and the pole 144 are housed inside the yoke 142. Further, the yoke 142, the magnet 143 and the pole 144 are fixed to and integrated with the bearing part 141 in a state in which the bearing part 141 penetrates the throughhole 142a of the yoke 142 and the ring holes of the magnet 143 and the pole 144.

The springs 161 and 162 are installed inside the case 110 in a state in which the shaft member 130 penetrates through the inside of the springs 161 and 162. Specifically, one end of the spring 161 abuts on the inner plane of the bottom portion 111 of the case 110 (the left side in the sheet of FIG. 2) where the first edge part 114 is provided, in a state in which the first edge part 114 is inserted in the spring 161. The other end of the spring 161 abuts on the locking groove 142b of the yoke 142 in a state in which the locking part 141a is inserted in the spring 161. In addition, one end of the spring 162 abuts on the end plane of the pole 144 in a state in which a convex part 144a, which is formed in the end plane of the pole 144, is inserted in the spring 162. The other end of the spring 162 abuts on the lid member 170 in a state in which the third edge part 172 is inserted in the spring 162. In principle, compression springs having the same spring constant and variation are used for the two springs 161 and 162.

The voice coil bobbin 145 is provided in the lid member 170. A voice coil (coil) 180 is provided at one end 145a of the voice coil bobbin 145, and the other end 145b of the voice coil bobbin 145 is fixed to the inner wall of the lid member 170. The one end 145a of the voice coil bobbin 145 is disposed between the outer peripheral plane of the pole 144 and the inner peripheral plane of the yoke 142.

As described above, the outer diameter of the pole 144 is smaller than the inner diameter of the yoke 142, so that a gap is provided between the inner peripheral plane of the yoke 142 and the outer peripheral plane of the pole 144 facing this inner peripheral plane. The one end 145a of the voice coil bobbin 145 is located in this gap, and the voice coil 180 is located between the yoke 142 and the pole 144. Further, a cable line 190 for inputting signals in the voice coil 180 is connected to the outside of the lid member 170.

The cylindrical vibration transmission member 150 is attached to the outer wall of the bottom portion 111 of the case 110. The vibration transmission member 150 is configured to receive the vibration generated from the back-and-forth movement of the movable part 140, from the case 110, and transmit the vibration away from the case 110. The vibration transmission member 150 is made of a material that has excellent properties for transmitting vibration, such as a metallic material. The vibration transmission member 150 assumes a cylindrical shape, and a space (inner space S1) is provided inside the vibration transmission member 150.

As described earlier, in the outer wall of the case 110 (the left-side wall of the case in FIG. 2), the first edge part 114 and the second edge part 115 form the annular groove 116 with a fixed distance X2. In addition, the cylindrical vibration transmission member 150 has a diameter to match the diameter of the annular groove 116, and has a thickness to match the distance X2. Consequently, by fitting one end of the vibration transmission member 150 into the annular groove 116, it allows to fix the one end of the vibration transmission member 150 in the annular groove 116.

At the other end of the vibration transmission member 150, an opening part 151 to serve as an end-part opening of the inner space S1 is provided. The vibration transmission member 150 communicates with the outside of the seat 10 from the opening part 151, through the space 13a in the cushion member 13. Consequently, the opening part 151 of the vibration transmission member 150 serves as an open end for connecting (opening) the inner space S1 with the outside of the seat 10.

Here, the inner diameter of the vibration transmission member 150 is wider than the diameter of the shaft member 130. Therefore, given the state in which the vibration transmission member 150 is fixed in the annular groove 116, the end part 133 of the shaft member 130 exposed to the outside of the case 110 is guided to the inner space S1 in the vibration transmission member 150, resulting in a state in which a gap (space) is provided between the inner peripheral plane of the vibration transmission member 150 and the outer peripheral plane of the shaft member 130.

Also, the longitudinal length of the vibration transmission member 150 is the length from the end part of the case 110 to the vicinity of the end part of the backrest 11 (to be more specific, as shown in FIG. 1, up to the space 13a formed with the cushion member 13). It then follows that the vibration that transmits to the vibration transmission member 150 through the case 110 is transmitted all over the backrest 11 by means of the long vibration transmission member 150. Note that the end part 133 of the shaft member 130 is in a state of being slightly exposed from the outer wall of the case 110 to the inside of the vibration transmission member 150, and the shaft member 130 is shorter than the vibration transmission member 150.

The vibration generator 100a thus configured is installed in the seat 10 so as to be the vibration generator 100a is embedded in the cushion member 13 of the backrest 11, as shown in FIG. 1. Given this state, when a current flows in the voice coil 180 through the cable line 190 of the vibration generator 100a, a force to act in the axial direction of the shaft member 130 is produced under the influence of the magnetic flux that is generated between the yoke 142 and the pole 144 (Fleming's left-hand rule). It then follows that, by the force acting in the axial direction, the movable part 140 including the yoke 142, the magnet 143, the pole 144 and the bearing part 141 integrally moves back and forth inside the case 110 along the shaft member 130.

The back-and-forth movement of the movable part 140 makes the movable part 140 move close and away with respect to the case 110, so that the action and reaction caused by each other's movement transmit amplified vibration to the case 110. It then follows that the vibration that is transmitted to the case 110 transmits to the vibration transmission member 150 fixed to the outer wall of the case 110 (bottom portion 111), and transmits in the direction in which the vibration transmission member 150 extends.

The vibration transmission member 150 is embedded in the cushion member 13 of the backrest 11, as shown in FIG. 1. The vibration that is transmitted through the vibration transmission member 150 is transmitted from the vibration transmission member 150 to the seated person in the seat 10, through the cushion member 13. Specifically, since the vibration transmission member 150 assumes a long cylindrical shape and is embedded so that the longitudinal direction of the vibration transmission member 150 runs along the longitudinal direction of the backrest 11, the seated person can feel vibrations of sufficient strength over a wide range of the backrest 11.

In addition, heat can be generated between or in the vicinity of the shaft member 130 and the bearing part 141 due to the back-and-forth movement of the movable part 140. In particular, if the amount of current to flow in the voice coil 180 of the vibration generator 100a increases and the movable part 140 moves back and forth faster or over a greater range, this may lead to generating an increased amount of heat.

With the vibration generator 100a according to the first embodiment, the heat that is generated between the shaft member 130 and the bearing part 141 is transmitted to the end part 133 of the shaft member 130 located outside the case 110 through the shaft member 130 having high thermal conductivity. The end part 133 of the shaft member 130 located outside the case 110 is being exposed to the inner space S1 in the vibration transmission member 150, so that the heat that is transmitted is released to the inner space S1.

In particular, a gap (space) is provided between the inner peripheral plane of the vibration transmission member 150 and the outer peripheral plane of the shaft member 130, so that the shaft member 130 and the vibration transmission member 150 are not in direct contact with each other. Consequently, the heat that is guided to the end part 133 of the shaft member 130 (outside the case 110) is released to the inner space S1 without being transmitted directly to the inner peripheral plane of the vibration transmission member 150. The heat released to the inner space S1 transmits in the inner space S1 following the direction in which the vibration transmission member 150 extends, and is released to the outside of the backrest 11 through the opening part 151 of the vibration transmission member 150 and the space 13a of the cushion member 13. In this way, the heat that is generated by the back-and-forth movement of the movable part 140 in the case 110 can be transmitted from the inside of the case 110 to the outside of the case 110 by means of the shaft member 130, and, furthermore, be released from the end part 133 of the shaft member 130 to the outside of the cushion member 13 through the inner space S1 and the opening part 151 of the vibration transmission member 150. Therefore, the heat generated in the vibration generator 100a can be effectively and quickly released to the outside of the seat 10, so that it is possible to improve the heat-releasing performance of the vibration generator 100a.

### Second Embodiment

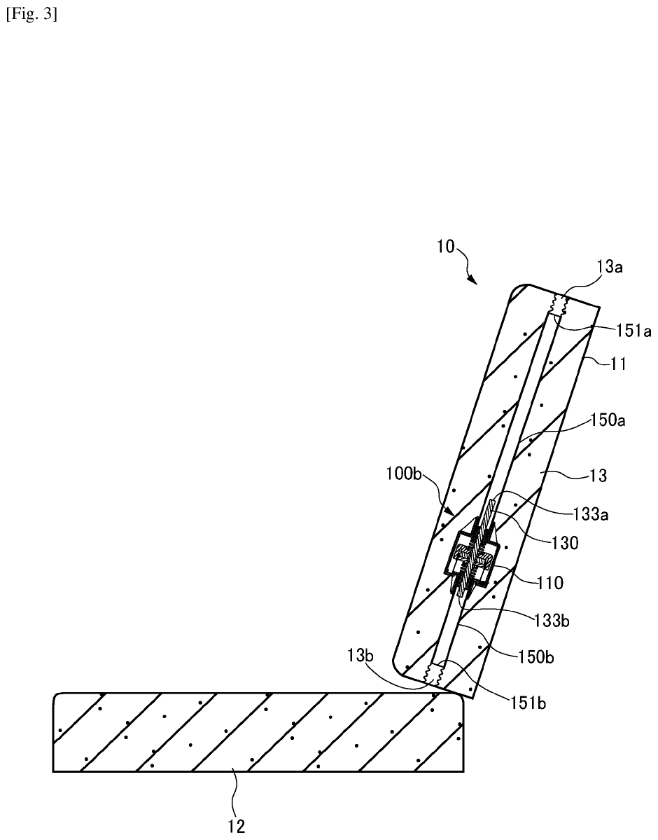

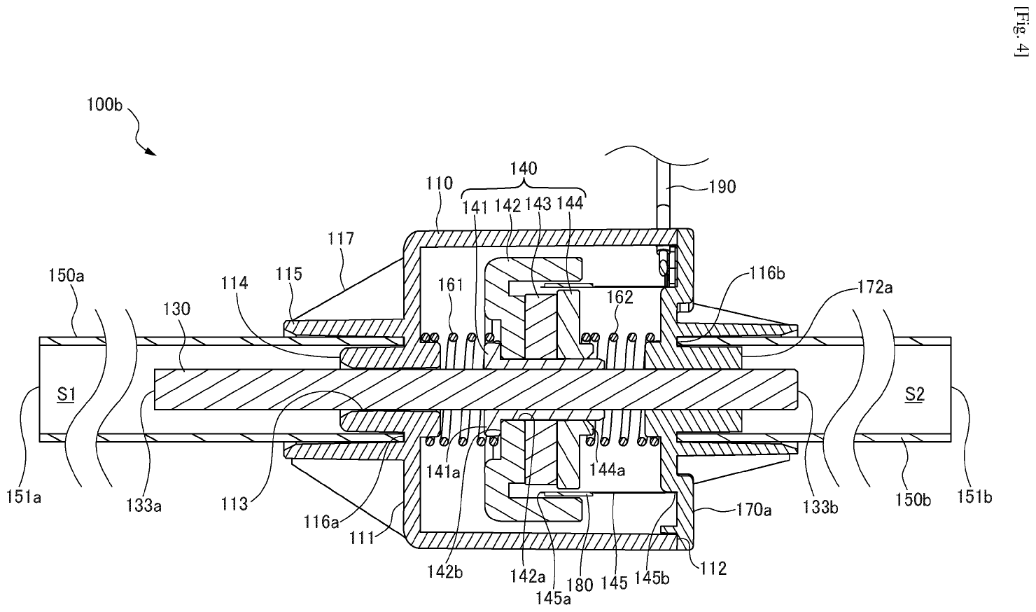

Next, a vibration generator 100b according to a second embodiment will be described. FIG. 3 is a cross-sectional side view showing a schematic configuration of the seat 10, where the vibration generator 100b is installed in the backrest 11. Also, FIG. 4 is a cross-sectional side view showing the vibration generator 100b. FIG. 4 is shown so that the longitudinal direction of the vibration generator 100b is the left-right direction on the drawing sheet. Note that, in FIG. 3 and FIG. 4, elements having the same configurations and functions as in the vibration generator 100a shown in FIG. 1 and FIG. 2 are given the same reference signs and detailed descriptions thereof will be omitted in the second embodiment.

The vibration generator 100b according to the second embodiment differs from the vibration generator 100a according to the first embodiment in that the lid member 170a has the approximately similar structure as the outer wall (bottom portion 111) of the case 110 located on the opposite side of the lid member 170a. Consequently, as shown in FIG. 4, the shaft member 130 is structured so that it is fixed to (arranged to penetrate) the center of the outer wall of the case 110 (bottom portion 111) and the center of the lid member 170a, so as to penetrate the inside of the case 110, and both ends 133a and 133b of the shaft member 130 are exposed to the outside of the case 110 and the lid member 170a. In addition, annular grooves 116a and 116b are formed in the outer walls of the case 110 and the lid member 170a, respectively, and the vibration transmission members 150a and 150b are attached to the case 110 and the lid member 170a, respectively, in a state in which the end parts of the vibration transmission members 150a and 150b are fitted and fixed in the annular grooves 116a and 116b, respectively. Note that the lid member 170a includes a third edge part 172a for fixing the shaft member 130.

As shown in FIG. 3, with the vibration generator 100b installed in the backrest 11, the end part of one vibration transmission member 150b extends to the vicinity of the lower end part of the backrest 11. An opening part 151b is provided at the end part of the vibration transmission member 150b. A space 13b is formed with the cushion member 13 of the backrest 11, in the vicinity of the lower end part of the vibration transmission member 150b, communicating with the lower outside of the seat 10 from the lower end part 133b of the shaft member 130, through the opening part 151b and the space 13b.

On the other hand, the end part of the other vibration transmission member 150a in the vibration generator 100b extends to the vicinity of the upper end part of the backrest 11. An opening part 151a is provided at the end part of the vibration transmission member 150a. A space 13a is formed with the cushion member 13 of the backrest 11, in the vicinity of the upper end part of the vibration transmission member 150a, communicating with the upper outside of the seat 10 from the upper end part 133a of the shaft member 130, through the opening part 151a and the space 13a.

In this way, the movable part 140 moves back and forth in a state in which both end parts 133a and 133b of the shaft member 130 penetrate (penetrate through) the outer walls of the case 110 and the lid member 170a and are exposed from the inside to the outside of the case 110, so that the heat that is generated between the shaft member 130 and the bearing part 141 of the movable part 140, is transmitted to the shaft member 130, and transmitted to both end parts 133a and 133b of the shaft member 130. Both end parts 133a and 133b of the shaft member 130 are being exposed to the inner spaces S1 and S2 of the vibration transmission members 150a and 150b, from the outer walls of the case 110 and the lid member 170a, and the heat transmitted to the end parts 133a and 133b of the shaft member 130 is released to the inner spaces S1 and S2 of vibration transmission members 150a and 150b without being transmitted directly to the inner peripheral planes of the vibration transmission members 150a and 150b. The heat released to the inner spaces S1 and S2 transmits in the inner spaces S1 and S2 following the direction in which the vibration transmission members 150a and 150b extend, and is released to the outside of the backrest 11 through the opening parts 151a and 151b of the vibration transmission members 150a and 150b and the spaces 13a and 13b of the cushion member 13.

In this way, the heat that is generated by the back-and-forth movement of the movable part 140 in the case 110 can be released from the inside to the outside of the case 110, by means of the shaft member 130, and, furthermore, released from both ends 133a and 133b of the shaft member 130 to the outside of the cushion member 13 through the inner spaces S1 and S2 of the vibration transmission members 150a and 150b, respectively. Therefore, the heat that is generated in the vibration generator 100b can be released to the outside of the seat 10, effectively and quickly, through multiple heat transmission paths (inner spaces S1 and S2 of vibration transmission members 150a and 150b), so that it is possible to effectively reduce the temperature increase in the vibration generator 100b and to improve its heat-releasing performance.

### Third Embodiment

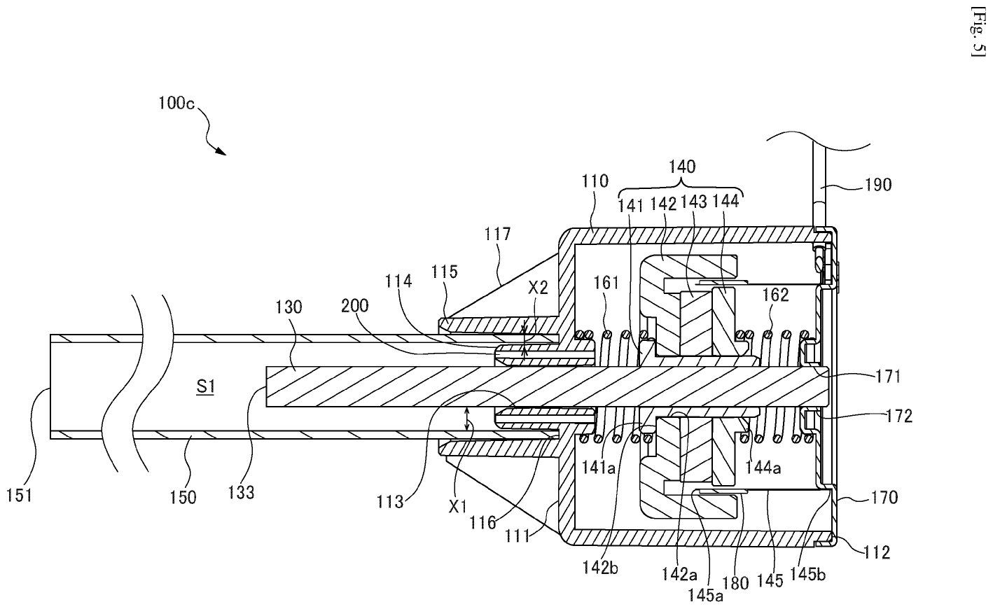

Next, a vibration generator 100c according to a third embodiment will be described. FIG. 5 is a side cross-sectional view showing the vibration generator 100c. FIG. 5 is shown so that the longitudinal direction of the vibration generator 100c is the left-right direction on the drawing sheet. In FIG. 5, elements having the same configurations and functions as in the vibration generator 100a shown in FIG. 2 are given the same reference signs and detailed descriptions thereof will be omitted in the third embodiment.

The vibration generator 100c according to the third embodiment differs from the vibration generator 100a according to the first embodiment in that communicating holes 200 that communicate from the inside to the outside of the case 110 are provided in the first edge part 114. Multiple communicating holes 200 are provided in a scattered pattern so as to be equidistant from the center of the throughhole 113 of the case 110.

As mentioned earlier, heat can be generated between the shaft member 130 and the bearing part 141 due to the back-and-forth movement of the movable part 140. In addition, heat may be generated not only between the shaft member 130 and the bearing part 141, and also may be generated in the voice coil 180 depending on the amount of current that flows in the voice coil 180. Consequently, when the movable part 140 moves back and forth inside the case 110, the temperature inside the case 110 may increase due to the heat generated between the shaft member 130 and the bearing part 141, and the heat generated in the voice coil 180. As a result, heat may be enclosed inside the case 110.

With the vibration generator 100c according to the third embodiment, multiple communicating holes 200 are formed in one wall plane of the case 110 (the first edge part 114 of the bottom portion 111). Consequently, when the movable part 140 moves back and forth inside the case 110, the air (hot air) inside the case 110 is discharged from the communicating holes 200 to the outside of the case 110 as the movable part 140 moves forward, and air (air with relatively low temperature) outside the case 110 flows into the case 110 through the communicating holes 200 as the movable part 140 moves backward. By these discharge and inflow of air, the air inside the case 110 circulates actively, so that it is possible to actively lower the temperature inside the case 110.

Furthermore, the vibration transmission member 150 attached to the outside of the case 110 assumes a cylindrical shape, and communicates with the outside of the seat 10 through the opening part 151 of the vibration transmission member 150 and the space 13a in the cushion member 13. Consequently, it is possible to smoothly discharge the air that is discharged in the outside of the case 110 to the outside of the seat 10 (backrest 11), and to introduce the air outside the seat 10 (backrest 11) into the case 110.

Moreover, as is the case with the vibration generator 100a according to the first embodiment, heat that is generated between the shaft member 130 and the bearing part 141 of the movable part 140 in the vibration generator 100c is transmitted to the outside of the case 110 through the shaft member 130. The heat transmitted to the outside of the case 110 is discharged to the outside of the backrest 11 through the opening part 151 of the vibration transmission member 150 and the space 13a in the cushion member 13.

In this way, with the vibration generator 100c, the air (hot air) that is generated by the back-and-forth movement of the movable part 140 inside the case 110 can be discharged to the outside of the case 110, through the communicating holes 200 formed in the first edge part 114, and, in addition, the heat can be released to the outside of the case 110 by means of the shaft member 130. Then, the air/heat discharged/released to the outside of the case 110 can be discharged from the end part 133 of the shaft member 130, to the outside of the backrest 11, through the inner space S1, the space 13a and so forth in the vibration transmission member 150. Therefore, the heat generated in the vibration generator 100c can be discharged to the outside of the seat 10, effectively and quickly, so that it is possible to reduce the temperature increase in the vibration generator 100c and to improve its heat-releasing performance.

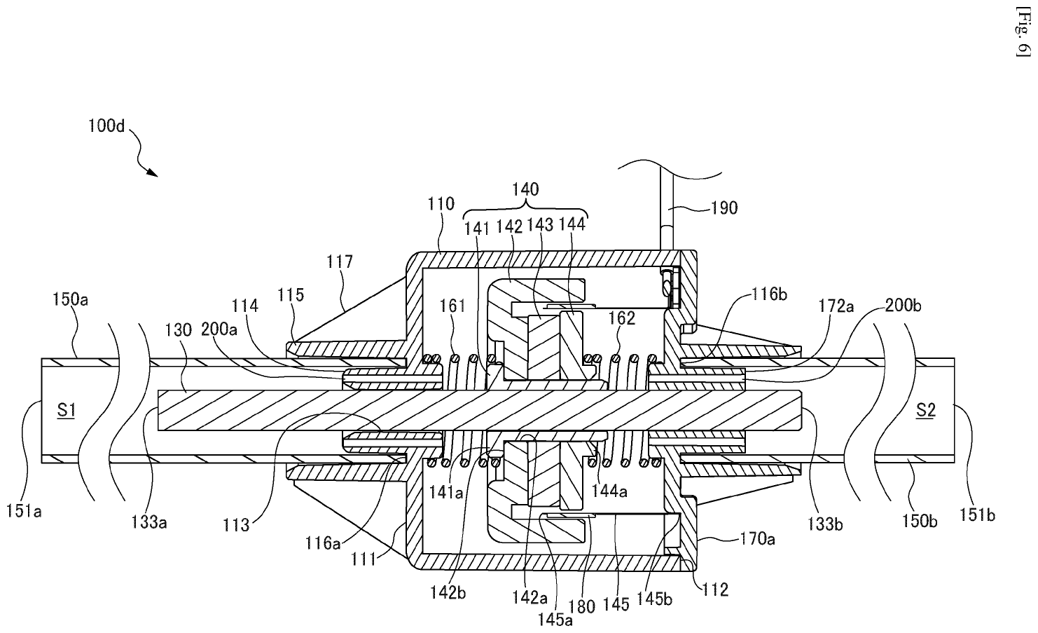

Note that, as shown in FIG. 6, multiple communicating holes 200a and 200b may be provided in the first edge part 114 and the third edge part 172a of the vibration generator 100b shown in FIG. 3 and FIG. 4, respectively. With the vibration generator 100d shown in FIG. 6, communicating holes 200a and 200b are formed in the respective side planes of the case 110. That is, the communicating holes 200a and 200b are formed in the first edge part 114 and the third edge part 172a on the side corresponding to the direction in which the movable part 140 moves forward and on the side corresponding to the direction in which the movable part 140 moves backward, respectively. Further, the vibration transmission members 150a and 150b are provided at the respective side planes of the case 110 where the communicating holes 200a and 200b formed, and inner spaces S1 and S2 that communicate with different end parts of the backrest 11 are formed.

When the movable part 140 moves forward, while the air (hot air) inside the case 110 is discharged to the outside of the case 110 from the communicating holes 200a on the forward-direction side, air (air with relatively low temperature) outside the case 110 is guided into the case 110 from the communicating holes 200b on the opposite side. On the other hand, when the movable part 140 moves backward, while the air (hot air) inside the case 110 is discharged to the outside of the case 110 from the communicating holes 200b on the backward-direction side, air (air with relatively low temperature) outside the case 110 is guided into the case from the communicating holes 200a on the opposite side.

In this way, when the movable part 140 moves back and forth, the air inside the case 110 switches with outside air as the movable part 140 moves forward and backward, so that it allows for circulating the air inside the case 110 and discharging the heat actively. Accordingly, it is possible to actively reduce the temperature increase in the vibration generator 100d and to improve its heat-releasing performance.

### Fourth Embodiment

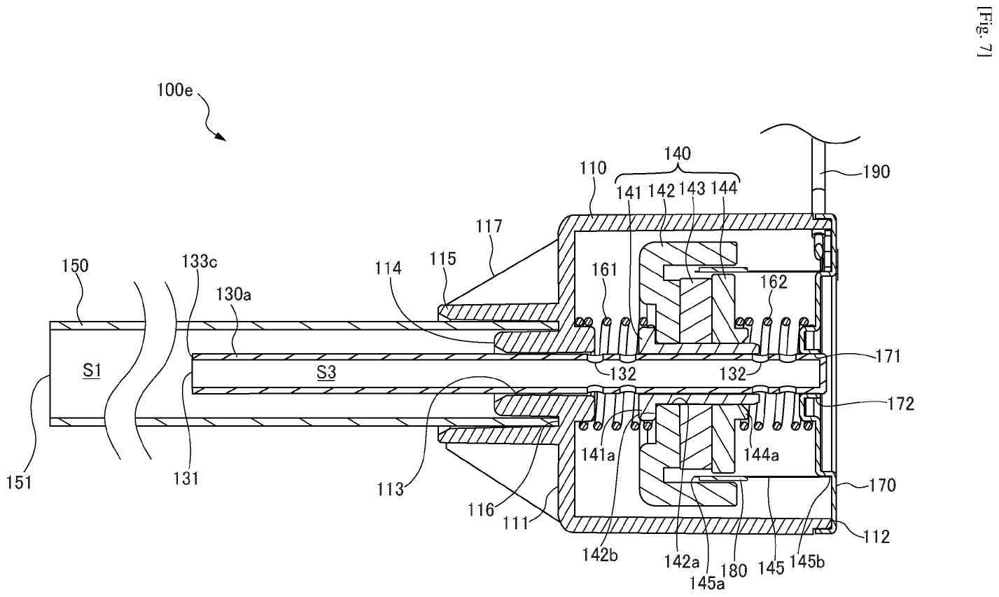

Next, a vibration generator 100e according to a fourth embodiment will be described. FIG. 7 is a cross-sectional side view showing the vibration generator 100e. FIG. 7 is shown so that the longitudinal direction of the vibration generator 100e is the left-right direction on the drawing sheet. In FIG. 7, elements having the same configurations and functions as in the vibration generator 100a shown in FIG. 2 are given the same reference signs and detailed descriptions thereof will be omitted in the fourth embodiment.

The vibration generator 100e according to the fourth embodiment differs from the vibration generator 100a according to the first embodiment in that the inside of the shaft member is hollow (hollow space S3). Specifically, the shaft member 130a assumes a cylindrical shape, and a hollow space S3 is provided inside, and an end part opening 131 is formed in one end part 133c of the shaft member 130a. Meanwhile, the opposite end part of the shaft member 130a is closed.

In addition, multiple peripheral-plane openings 132 that connect with the inside of the case 110 are formed in the peripheral plane of the shaft member 130a located on the inner side of the springs 161 and 162. The peripheral-plane openings 132 of the shaft member 130a are provided at inner locations of the springs 161 and 162 on both sides the movable part 140 moves forward and backward. Consequently, when the movable part 140 moves forward, at least the peripheral-plane openings 132 on the backward side are open to the inside of the case 110, and, when the movable part 140 moves backward, at least the peripheral-plane openings 132 on the forward side are open to the inside of the case 110.

With the vibration generator 100e according to the fourth embodiment, when the movable part 140 move back and forth in a state in which the hollow space S3 is formed inside the shaft member 130a and a path to communicate between the inside of the case 110 and the outside of the case 110 is provided, the air inside the case 110 (hot air) is conveyed from the peripheral-plane openings 132 to the end-part opening 131, through the hollow space S3 of the shaft member 130a, by the back-and-forth movement of the movable part 140, and carried out of the case 110. In particular, since multiple peripheral-plane openings 132 are provided in locations corresponding to both sides where the movable part 140 moves forward and backward, the peripheral-plane openings 132 are open for sure whether the movable part 140 moves forward or backward, and the air (hot air) can be smoothly discharged to the outside of the case 110.

The air (hot air) discharged to the outside of the case 110 travels through the inner space S1 of the vibration transmission member 150, and is discharged to the outside of the backrest 11. On the other hand, when the movable part 140 moves back and forth, air outside the backrest 11 (air with relatively low temperature) travels through the inner space S1 of the vibration transmission member 150, and is taken into the case 110 through the hollow space S3 of the shaft member 130a.

Furthermore, the heat that is generated between the shaft member 130a and the bearing part 141 of the movable part 140 is also discharged to the outside of the case 110, through the shaft member 130a or the hollow space S3. In this way, the heat that is generated inside the case 110 by the back-and-forth movement of the movable part 140 is discharged to the outside of the case 110 through the peripheral-plane openings 132 and the end-part opening 131 of the shaft member 130a, and, furthermore, discharged to the outside of the backrest 11 through the inner space S1 of the vibration transmission member 150. Thus, it is possible to circulate the air inside the case 110 actively, so that the temperature increases inside the case 110 can be reduced, and its heat-releasing performance can be improved.

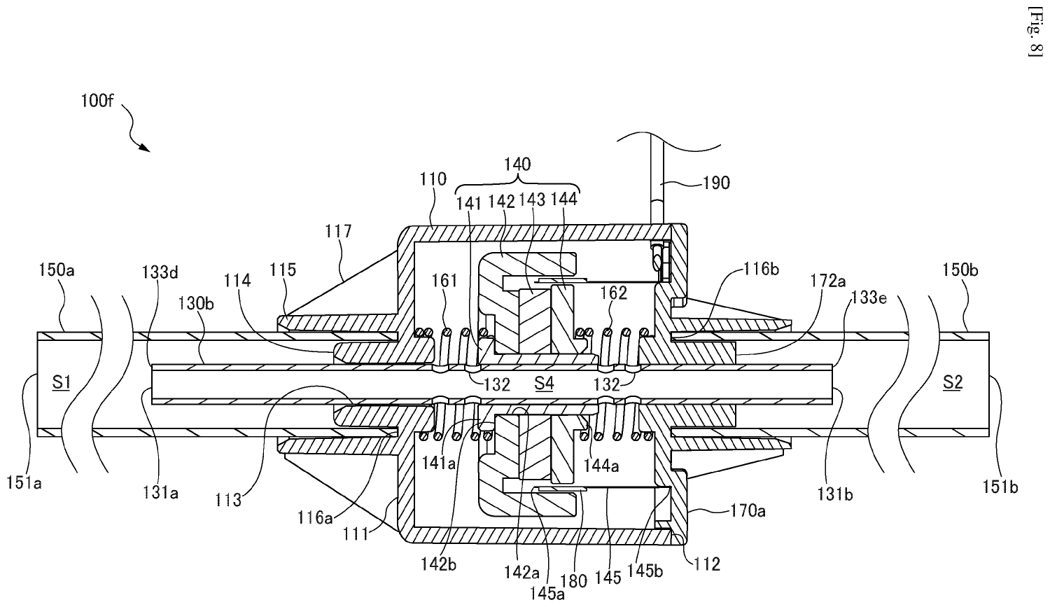

Note that, as shown in FIG. 8, a hollow space S4 may be formed to penetrate from one end part to the other end part in the shaft member of the vibration generator 100b shown in FIG. 3 and FIG. 4. Further, in addition to the above, multiple peripheral-plane openings 132 shown in FIG. 7 may be formed on peripheral plane of the shaft member located on the inner side of the springs 161 and 162. Specifically, in the shaft member 130b of the vibration generator 100f where vibration transmission members 150a and 150b are provided at both ends of the case 110, a hollow space S4 is formed, and both ends 133d and 133e are opened by means of the end-part openings 131a and 131b, and, furthermore, the peripheral-plane openings 132 are provided on peripheral plane.

Given the vibration generator 100f configured this way, when the movable part 140 is moved forward, it is possible to guide the airflow inside the case 110 from one vibration transmission member 150b to the other vibration transmission member 150a, so that, when the movable part 140 is moved backward, the airflow can be guided to the reverse direction. Consequently, as the movable part 140 moves back and forth, the air inside the case 110 (hot air) can be discharged from one end part of the backrest 11, while guiding air (air with relatively low temperature) into the case 110 from the other end part of the backrest 11, so that it allows for circulating the air inside the case 110 efficiently. Therefore, it is possible to reduce the temperature increase in the vibration generator 100f and to improve its heat-releasing performance.

While the vibration generators according to embodiments of the present invention have been described in detail with reference to the drawings, the vibration generators are not limited to the structures of the vibration generators 100a to 100f described with the first to fourth embodiments. For example, cases have been described with the vibration generators 100a to 100f of the first to fourth embodiments in which the vibration generators 100a to 100f are embedded inside the seat 10, or, to be more specific, inside the cushion member 13 of the backrest 11. However, the vibration generators are not limited to configurations in which the vibration generators are installed in the seat.

For example, a vibration generator may be installed in a cushioning seat cover that can be attached to and detached from the seat. Nowadays, cushioning seat covers in which the backrest and others are processed three-dimensionally with emphasis on support for the waist part and the side parts of the back are commercially available. By embedding a vibration generator in the cushion member or the like of the three-dimensionally shaped part, the same effects as those of the vibration generators 100a to 100f shown in the first to fourth embodiments can be achieved. In addition, by applying the cushioning seat cover installed a vibration generator to the commercially available seat, it is easy to notify or alarm the user by way of vibration. Therefore, a vibration generator can be applied to any seat, regardless of the type and structure of the seat.

Furthermore, a vehicle seat can be used as an example of a seat to install a vibration generator according to one embodiment of the present invention in. Nowadays, alarm systems have been proposed, whereby the driver is given notice when the vehicle deviates from the border line (white line, etc.) of the traveling lane, when there is an obstacle ahead, and so forth. By installing a vibration generator in the vehicle seat, it is possible to give notice to the driver by way of vibration.

In addition, today, as one way of producing amusing effects for games, a system to give the player vibrations that are linked with games has been proposed. If a vibration generator is installed in a seat for gaming, it is possible to produce various vibrations depending on the content/situation of games, and to improve the production of amusing effects.

In addition, cases have been described with the vibration generators according to the first to fourth embodiments, where the longitudinal direction of a vibration generator runs along the vertical direction of the backrest. However, the orientation in which a vibration generator is installed does not have to match the vertical direction of the backrest, and a vibration generator may be installed so that the longitudinal direction of the vibration generator is the left-right direction of the backrest, or may be installed diagonally. In addition, when a vibration generator is installed in the seating portion, the headrest, the elbow rest part and so forth, the vibration generator can be installed so that the longitudinal direction of the vibration generator is the seating portion's left-right direction, front-rear direction, diagonal direction and so forth.

Also, when installing vibration generators in a seat or seat cover, the number of vibration generators to install is not necessarily limited to one, and a number of vibration generators can be installed. For example, by installing vibration generators both on the left and right-side portions of the backrest, it allows the seated person's back and side to feel vibrations from the right side and vibrations from the left side separately.

### REFERENCE SIGNS LIST

10 seat; 11 backrest (of seat); 12 seating portion (of seat); 13 cushion member (of seat); 13a, 13b space (in cushion member); 100a, 100b, 100c, 100d, 100e, 100f vibration generator; 110 case; 111 the bottom portion (of case); 112 opening portion (of case); 113 throughhole (of case); 114 first edge part (of case); 115 second edge part (of case); 116, 116a, 116b annular groove (of case); 117 rib; 130, 130a, 130b shaft member; 131, 131a, 131b end part opening (of shaft member); 132 peripheral-plane opening (of shaft member); 133, 133a, 133b, 133c, 133d, 133e end parts (of shaft member); 140 movable part (moving part); 141 bearing part (of movable part); 141a locking part (of shaft member); 142 yoke (of movable part); 142a throughhole (of yoke); 142b locking groove (of yoke); 143 magnet (of movable part); 144 pole (of movable part); 144a convex part (of pole); 145 voice coil bobbin; 145a one end (of voice coil bobbin); 145b other end (of voice coil bobbin); 150, 150a, 150b vibration transmission member; 151, 151a, 151b opening part (of vibration transmission member); 161, 162 spring; 170, 170a lid member; 171 opening part (of lid member); 172, 172a third edge part (of lid member); 180 voice coil; 190 cable line; 200, 200a, 200b communicating hole (of case); S1, S2 inner space (of vibration transmission member); S3, S4 hollow space (of shaft member)

1. A vibration generator comprising:
a case;
a shaft member provided inside the case;
a moving part configured to move back and forth inside the case along the shaft member; and
a vibration transmission member configured to have one end fixed to the case, wherein:
the vibration transmission member comprises an inner space formed therein and an opening part to connect between the inner space and outside; and
an end part of the shaft member penetrates out from the inside of the case, and extends to the inner space of the vibration transmission member.

2. The vibration generator according to claim 1, wherein the case comprises a communicating hole to connect between the inner space of the vibration transmission member and the inside of the case.

3. The vibration generator according to claim 2, wherein:
the vibration transmission member is provided at one end of the case on a side corresponding to a direction in which the moving part moves forward, and also provided, separately, at the other end of the case on a side corresponding to a direction in which the moving part moves backward; and
the communicating hole is formed at the one end of the case on the side corresponding to the direction in which the moving part moves forward, and also formed, separately, at the other end of the case on the side corresponding to the direction in which the moving part moves backward.

4. The vibration generator according to any one of claims 1 to 3, wherein the shaft member comprises a hollow space connecting between the inner space of the vibration transmission member and the inside of the case.

5. The vibration generator according to claim 4, wherein:
the vibration transmission member is provided at the one end of the case on the side corresponding to the direction in which the moving part moves forward, and also provided, separately, at the other end of the case on the side corresponding to the direction in which the moving part moves backward; and
the shaft member comprises a hollow space connecting between the inner space of the vibration transmission member provided at the one end of the case, and the inside of the case, and a hollow space connecting between the inner space of the vibration transmission member provided at the other end of the case, and the inside of the case.
